(19) United States
(12) Patent Application Publication
(10) Pub. No.: US 2026/0260000 A1
(43) Pub. Date: Sep. 3, 2026

(54) ENCRYPTED VIRTUAL MEDIA TO PREVENT DISCLOSURE OF CONFIDENTIAL BOOTABLE MEDIA

(71) Applicant: Dell Products L.P., Round Rock, TX (US)

(72) Inventors: Scott Michael RAMSEY, Cedar Park, TX (US); Michael Emery BROWN, Austin, TX (US); Trevor Christian COCKRELL, Hutto, TX (US); Sandesh BALAKRISHNA, Bangalore (IN); Jitendra KUMAR, Bangalore (IN)

(73) Assignee: Dell Products L.P., Round Rock, TX (US)

(21) Appl. No.: 19/067,324

(22) Filed: Feb. 28, 2025

(51) Int. Cl. G06F 21/60; G06F 21/12; G06F 21/79

(52) U.S. Cl. CPC G06F 21/602; G06F 21/125; G06F 21/606; G06F 21/79

(57) ABSTRACT

An information handling system may include a host system including a hardware component, and a management controller configured to provide out-of-band management of the information handling system. The management controller may be configured to cause the host system to boot from a bootstrap image stored at the management controller, wherein the bootstrap image includes a cryptographic key. The host system may be configured to: use the cryptographic key to decrypt an encrypted diagnostic utility image; and execute code from the decrypted diagnostic utility image to perform a diagnostic of the hardware component.

### TECHNICAL FIELD

The present disclosure relates in general to systems, and more particularly to information handling techniques for running programs such as diagnostic utilities containing confidential information, without disclosing that information.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include information handling resources such as graphics processing units (GPUS) and other hardware components from various manufacturers. To address malfunctions of such components, the manufacturer or vendor of the component (referred to herein generally as the “component vendor”) may provide a diagnostic utility to be run on the affected system. Running such a utility allows support personnel from the manufacturer or vendor of the overall information handling system (referred to herein as the “system vendor”) to determine if there is a real physical problem that requires component replacement, or if there is some other issue that is unrelated to physical hardware problems.

To aid in the investigation of a component, the diagnostic utility may include confidential information (e.g., relating to the details of the hardware implementation of the component). Even if a non-disclosure agreement exists between the component vendor and the system vendor to allow personnel from the system vendor to run the utility, that may not be sufficient to authorize end users to access the utility.

Accordingly, it is often the case that a technician from the system vendor needs to go on-site to supervise the running of the component vendor's diagnostic utility. In situations with long-running diagnostic utilities, this can involve multiple site visits, incurring substantial costs. Accordingly, it would be desirable to be able to distribute the diagnostic utilities in a way that allows the end user to run them, but without allowing the end user unrestricted access to the actual binaries/scripts/data that include the confidential material.

Embodiments provide techniques for allowing an end user to securely run a diagnostic utility without being given access to any confidential information contained therein.

Embodiments may also address the problem of an end user returning apparently bad hardware, but the system vendor then finding no fault. For example, a fault may appear only in the production environment, and so being able to run the vendor's diagnostic utility in that environment provides benefits.

It should be noted that the discussion of a technique in the Background section of this disclosure does not 5 constitute an admission of prior-art status. No such admissions are made herein, unless clearly and unambiguously identified as such.

### SUMMARY

In accordance with the teachings of the present disclosure, the disadvantages and problems associated with running software containing confidential information may be reduced or eliminated.

In accordance with embodiments of the present disclosure, an information handling system may include a host system including a hardware component, and a management controller configured to provide out-of-band management of the information handling system. The management controller may be configured to cause the host system to boot from a bootstrap image stored at the management controller, wherein the bootstrap image includes a cryptographic key. The host system may be configured to: use the cryptographic key to decrypt an encrypted diagnostic utility image; and execute code from the decrypted diagnostic utility image to perform a diagnostic of the hardware component.

In accordance with these and other embodiments of the present disclosure, a method may include a management controller of an information handling system that is configured to provide out-of-band management of the information handling system causing a host system of the information handling system to boot from a bootstrap image stored at the management controller, the bootstrap image including a cryptographic key; the host system using the cryptographic key to decrypt an encrypted diagnostic utility image; and the host system executing code from the decrypted diagnostic utility image to perform a diagnostic of a hardware component of the host system.

In accordance with these and other embodiments of the present disclosure, an article of manufacture may include a non-transitory, computer-readable medium having computer-executable instructions thereon that are executable by a management controller of an information handling system that is configured to provide out-of-band management of the information handling system for: causing a host system of the information handling system to boot from a bootstrap image stored at the management controller, the bootstrap image including a cryptographic key; wherein the host system is configured to use the cryptographic key to decrypt an encrypted diagnostic utility image; and wherein the host system is configured to execute code from the decrypted diagnostic utility image to perform a diagnostic of a hardware component of the host system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which reference numbers indicate like features, and wherein:

FIG. 1 illustrates a block diagram of an example information handling system, in accordance with embodiments of the present disclosure; and

FIG. 2 illustrates a block diagram of another example information handling system, in accordance with embodiments of the present disclosure.

### DETAILED DESCRIPTION

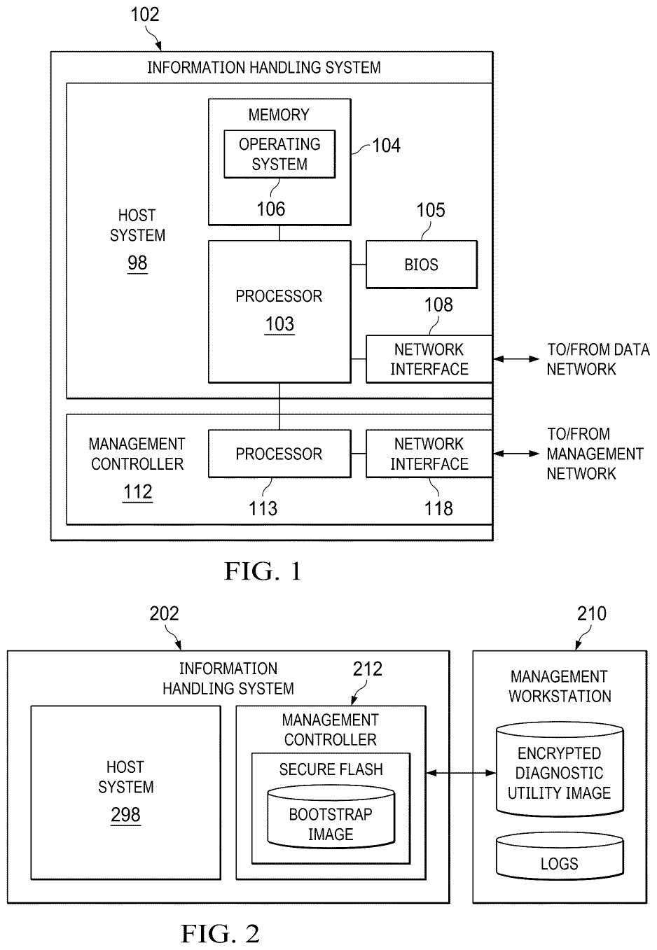

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality f servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions for aggregation of programs executable of instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure are directed to techniques for allowing an end user of an information handling system to run diagnostic utilities without disclosure of confidential information contained therein.

In some cases, it may be possible to run the diagnostics utilities securely directly from management controller 112, without disclosing their internal details to an end user of information handling system 102. However, storage space in management controllers is often limited, and the size of the utilities and their associated data can be significant.

Embodiments thus provide for distribution of diagnostic utilities as encrypted “blobs” that the end user cannot decrypt.

An encrypted filesystem image (e.g., an ISO) that contains diagnostics utilities may be distributed to the end user's system. A management controller of the system may then cause the host information handling system to boot from a separate bootstrap image that the management controller controls, which then decrypts and launches the utility from the encrypted image. The bootstrap process is contained in the management controller, and the encrypted diagnostics utility image may be attached to the host via the management controller virtual media facility, a physical USB stick containing the encrypted image, a dedicated diagnostic partition, etc.

Embodiments may also provide for the ability to restrict what hardware a given diagnostic utility may run on, preventing it from running on unapproved hardware. For example, embodiments may include a signed hash of the diagnostic utility image and machine-specific information to allow the bootstrap image to check that the image is only being used on approved information handling systems.

FIG. 2 shows one example implementation including selected components of information handling system 202. A management workstation 210 may communicatively couple to a management controller 212 of information handling system 202. For example, management workstation 210 may be operated by the system vendor, and it may couple to information handling system 102 over the internet, allowing the system vendor to run local diagnostics at a customer's datacenter without having to dispatch a technician to the site.

This implementation relies on three components: a read-only unencrypted bootstrap image (which may be stored at management controller 212), a read-only encrypted diagnostic utility image (which may be stored at management workstation 210 and made available over the network), and a writable logging image (which may also be stored at management workstation 210 or in any other suitable location).

In one embodiment, the bootstrap image may be stored in secure flash storage of management controller 212. In other embodiments, it may be attached to information handling system 202 via USB storage or the like. The encrypted diagnostic utility image may be shared to management controller 212 from management workstation 210 and then mounted for host system 298 via a virtual media function of management controller 212, or it may be attached to information handling system 202 via USB storage. The logging image may also be shared from management workstation 10 and mounted via a virtual media function of management controller 212, or it may be attached to information handling system 202 via USB storage (e.g., as one partition of a USB storage device).

The bootstrap image may be stored on and managed by management controller 212 in one embodiment. This image may include a Linux kernel and ram disk, and it may be booted by the host system 298 via a side-channel interface (e.g., by being exposed to the host system as a bootable media drive). The bootstrap image may be designed to be small and self-contained to fit in the limited storage available in management controller 212. The bootstrap image may also include the cryptographic key necessary for decrypting the encrypted diagnostic utility image (e.g., a key according to any desired symmetric or asymmetric cryptosystem). When booted, the bootstrap image may scan for the encrypted diagnostic image, decrypt it, mount it, and transfer control to it.

In particular, management controller 212 may be configured to securely force host system 298 to boot from the bootstrap image without making it otherwise available to the end user or the host OS. To accomplish this, management controller 212 may access the BIOS of host system 298 and set a boot order option to specify the bootstrap image. Management controller 212 may then force a power cycle of host system 298 to cause it to boot the bootstrap image. The image thus boots without the possibility of bootstrap loading any code from the (potentially insecure) end-user environment. Management controller 212 may be configured to ensure that the bootstrap image is only made available after the host is power cycled and is executing secure BIOS code.

In some embodiments, the management controller may also disable certain BIOS options to prevent the end user from changing the boot process to attempt to access the bootstrap image. For example, some systems implement a keypress (e.g., F12) to allow a user to access BIOS options, and this functionality may be disabled by the management controller.

In one embodiment, management controller 212 may present the bootstrap image to host system 298 as a USB mass storage device to be booted from. It is conceivable, however, that through a programming error or other circumstances, the host OS might somehow gain access to such a mass storage device and expose the confidential information stored thereon. Accordingly, a different embodiment may further enhance security by placing the bootstrap image into a shared memory area that is accessible by both the management controller and the host system instead of using a standard virtualized mass storage device. For example, host system 298 may interact with management controller 212 as a PCI device that includes a special set of registers that may be used to access such a shared memory area. The data in the shared memory may be mapped into the address space of host system 298 and then booted from. This embodiment reduces the likelihood of an inadvertent disclosure of the confidential information in the encrypted diagnostic utility image.

While a single type of bootstrap image may be used in many different scenarios, the encrypted diagnostic utility image may be specific to a given hardware vendor or a specific type of device. It may be standardized in such a way that the bootstrap image may locate it, decrypt it, and transfer execution to it. Once the diagnostics utility is running, it may save its results to the logging location, which may also be encrypted in some embodiments to prevent disclosure of sensitive information to the end-user.

To limit execution of a diagnostic utility to a specific system, the bootstrap image and/or the diagnostic utility image may include a cryptographic signature indicating the system's unique service tag, a starting date, an ending date, and/or any other suitable restrictions. The signature may also include a hash of the image and a signed cryptographic hash of all of the preceding information. The boot process may then use a public key to check the local system's unique service tag against the encoded service tag in the image signature, check the local date against the date range, and check the image hash against the encoded image hash. If any of these checks fail, the image may prevent the boot process from proceeding.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a host system including a hardware component; and
a management controller configured to provide out-of-band management of the information handling system;
wherein the management controller is configured to cause the host system to boot from a bootstrap image stored at the management controller, wherein the bootstrap image includes a cryptographic key;
wherein the host system is configured to:
use the cryptographic key to decrypt an encrypted diagnostic utility image; and
execute code from the decrypted diagnostic utility image to perform a diagnostic of the hardware component.

2. The information handling system of claim 1, wherein the hardware component is a graphics processing unit (GPU).

3. The information handling system of claim 1, wherein the bootstrap image is stored in secure flash storage of the management controller.

4. The information handling system of claim 1, wherein the diagnostic utility image includes hardware-specific information relating to the information handling system to prevent execution of the code on unauthorized systems.

5. The information handling system of claim 1, wherein the encrypted diagnostic utility image is stored at a remote information handling system and shared with the management controller over a network connection.

6. The information handling system of claim 1, wherein the host system is further configured to store results of the diagnostic in an encrypted log.

7. A method comprising:
a management controller of an information handling system that is configured to provide out-of-band management of the information handling system causing a host system of the information handling system to boot from a bootstrap image stored at the management controller, the bootstrap image including a cryptographic key;
the host system using the cryptographic key to decrypt an encrypted diagnostic utility image; and
the host system executing code from the decrypted diagnostic utility image to perform a diagnostic of a hardware component of the host system.

8. The method of claim 7, wherein the hardware component is a graphics processing unit (GPU).

9. The method of claim 7, wherein the bootstrap image is stored in secure flash storage of the management controller.

10. The method of claim 7, wherein the diagnostic utility image includes hardware-specific information relating to the information handling system to prevent execution of the code on unauthorized systems.

11. The method of claim 7, wherein the encrypted diagnostic utility image is stored at a remote information handling system and shared with the management controller over a network connection.

12. The method of claim 7, further comprising the host system storing results of the diagnostic in an encrypted log.

13. An article of manufacture comprising a non-transitory, computer-readable medium having computer-executable instructions thereon that are executable by a management controller of an information handling system that is configured to provide out-of-band management of the information handling system for:
causing a host system of the information handling system to boot from a bootstrap image stored at the management controller, the bootstrap image including a cryptographic key;
wherein the host system is configured to use the cryptographic key to decrypt an encrypted diagnostic utility image; and
wherein the host system is configured to execute code from the decrypted diagnostic utility image to perform a diagnostic of a hardware component of the host system.

14. The article of manufacture of claim 13, wherein the hardware component is a graphics processing unit (GPU).

15. The article of manufacture of claim 13, wherein the bootstrap image is stored in secure flash storage of the management controller.

16. The article of manufacture of claim 13, wherein the diagnostic utility image includes hardware-specific information relating to the information handling system to prevent execution of the code on unauthorized systems.

17. The article of manufacture of claim 13, wherein the encrypted diagnostic utility image is stored at a remote information handling system and shared with the management controller over a network connection.

18. The article of manufacture of claim 13, wherein the host system is further configured to store results of the diagnostic in an encrypted log.
